(19) United States
(12) Patent Application Publication
(10) Pub. No.: US 2020/0019094 A1
(43) Pub. Date: Jan. 16, 2020

(54) IMAGE FORMING APPARATUS

(71) Applicant: FUJI XEROX CO., LTD., Tokyo (JP)

(72) Inventors: Yuichi OMORI, Kanagawa (JP); Masayuki YOSHIDA, Kanagawa (JP)

(73) Assignee: FUJI XEROX CO., LTD., Tokyo (JP)

(21) Appl. No.: 16/290,966

(22) Filed: Mar. 4, 2019

(30) Foreign Application Priority Data
Jul. 13, 2018 (JP) 2018-133347

(51) Int. Cl. G03G 15/16; G03G 15/00

(52) U.S. Cl. CPC G03G 15/167; G03G 15/6535; G03G 15/161

(57) ABSTRACT

An image forming apparatus includes: an image carrying unit that carries and rotates an unfixed image to be transferred to a recording medium; a first separating unit that separates the recording medium from the image carrying unit with a first leading end of the first separating unit, in contact with the image carrying unit; and a second separating unit that separates the recording medium from the image carrying unit with a second leading end of the second separating unit, not in contact with the image carrying unit. The second separating unit is disposed so that the first leading end is at a same position as the first leading end of the first separating unit or at a position on an upstream side of the first leading end of the first separating unit in a rotation direction of the image carrying unit.

### CROSS-REFERENCE TO RELATED APPLICATIONS

This application is based on and claims priority under 35 USC 119 from Japanese Patent Application No. 2018-133347 filed Jul. 13, 2018.

### BACKGROUND

### (i) Technical Field

The present disclosure relates to an image forming apparatus.

### (ii) Related Art

In related, as an image forming apparatus that when a recording medium is separated from an image carrying unit such as a rotating photoconductor, prevents developer (toner) from adhering to the recording medium, the image forming apparatus disclosed in Japanese Unexamined Patent Application Publication No. 2008-158137 (paragraphs 0029 to 0030, FIG. 2) is known, for instance.

Japanese Unexamined Patent Application Publication No. 2008-158137 describes an image forming apparatus including a separating unit that separates a recording medium from the surface of a photoconductor drum and guides the recording medium in a transport direction, the separating unit including a separation claw that comes into contact with the photoconductor drum, and auxiliary claws that are disposed on both sides of the separation claw and are not in contact with the photoconductor drum. The auxiliary claws guide transport so that a recording medium separated by the separation claw does not come into contact with the back of the separation claw. Japanese Unexamined Patent Application Publication No. 2008-158137 describes that the image forming apparatus is formed so that the leading ends of the auxiliary claws are closer to the photoconductor drum than the back of the separation claw is.

### SUMMARY

Aspects of non-limiting embodiments of the present disclosure relate to an image forming apparatus capable of reducing contamination of the rear end of a recording medium at the time of transport due to adherence of developer at the leading end of the first separating unit to the rear end, as compared with the case where a leading end, not in contact with an image carrying unit, of a second separating unit is disposed at a position on the downstream side of a leading end, in contact with the image carrying unit, of a first separating unit in a rotation direction of the image carrying unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: an image carrying unit that carries and rotates an unfixed image to be transferred to a recording medium; a first separating unit that separates the recording medium from the image carrying unit with a first leading end of the first separating unit, in contact with the image carrying unit; and a second separating unit that separates the recording medium from the image carrying unit with a second leading end of the second separating unit, not in contact with the image carrying unit. The second separating unit is disposed so that the first leading end is at a same position as the first leading end of the first separating unit or at a position on an upstream side of the first leading end of the first separating unit in a rotation direction of the image carrying unit.

### BRIEF DESCRIPTION OF THE DRAWINGS

Exemplary embodiments of the present disclosure will be described in detail based on the following figures, wherein:

FIG. 1 is a schematic view illustrating an entire image forming apparatus according to a first exemplary embodiment;

FIG. 2 is a schematic view illustrating part of the image forming apparatus of FIG. 1;

FIG. 3 is a schematic perspective view illustrating another part of the image forming apparatus of FIG. 1;

FIG. 4A is a schematic perspective view illustrating a sheet separator in the image forming apparatus, and FIG. 4B is a schematic view of the sheet separator of FIG. 4A as seen from a diagonal front;

FIG. 5 is an exploded perspective view illustrating a first separating unit and a second separating unit in the sheet separator;

FIG. 6 is a schematic view illustrating the sheet separator and its peripheral area as seen from one side;

FIG. 7 is a schematic view illustrating the sheet separator and its peripheral area as seen from the opposite side;

FIG. 8A is a schematic view illustrating an example of a state where the leading end of a sheet is naturally separated from an intermediate transfer belt and is moved to the sheet separator, and FIG. 8B is a schematic view illustrating an example of a state where the leading end of a sheet is secondarily separated by the second separating unit in the sheet separator and moved;

FIG. 9A is a schematic view illustrating an example of a state where the rear end of a sheet comes into contact with the leading end portion of the second separating unit in the sheet separator and is moved, and FIG. 9B is a schematic view illustrating an example of a state where the leading end portion of a thin sheet is separated by the first separating unit in the sheet separator, then is jammed;

FIG. 10 is a schematic view illustrating an example of a state where the rear end of a sheet comes into contact with the leading end portion of the second separating unit in the sheet separator, and is moved not in contact with the leading end portion of the first separating unit;

FIGS. 11A and 11B are conceptual views illustrating a state where the first separating unit and the second separating unit in the sheet separator are in contact with a sheet with both ends deformed, FIG. 11A illustrates the case of the sheet separator of FIG. 3, and FIG. 11B illustrates the case of a sheet separator to be compared;

FIG. 12A is a schematic view illustrating a sheet separator according to a modification, and FIG. 12B is a schematic view illustrating the function of the sheet separator of FIG. 12A;

FIG. 13 is a schematic view illustrating an example of a failure which may occur when no sheet separator is provided;

FIG. 14A is a schematic view illustrating the function of sheet separation when a sheet separator in related art is provided, and FIG. 14B is a schematic view illustrating an example of a state where dirt occurs at the rear end of a sheet in the sheet separator of FIG. 14A; and

FIG. 15 is an explanatory view illustrating an example of a state where dirt at the rear end of a sheet is noticeable.

### DETAILED DESCRIPTION

Hereinafter, an exemplary embodiment for practicing the present disclosure will be described with reference to the drawings.

### First Embodiment

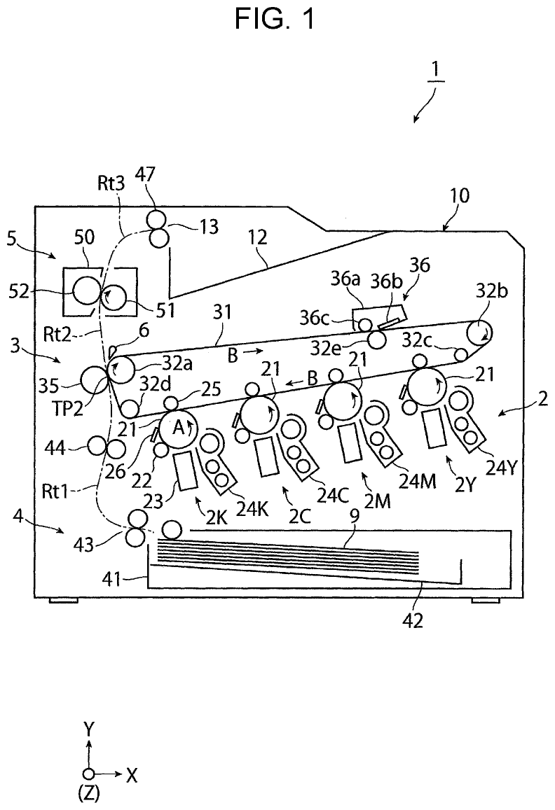

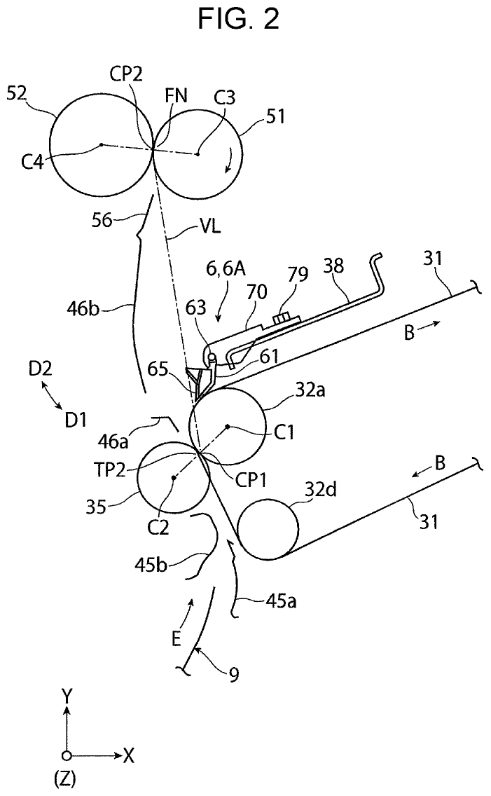

FIGS. 1 and 2 illustrate an image forming apparatus 1 according to a first exemplary embodiment. FIG. 1 illustrates the overall configuration of the image forming apparatus 1, and FIG. 2 illustrates the configuration of part (basically, a sheet separator at a second transfer position and its peripheral area) of the image forming apparatus 1. The arrows indicated by symbols X, Y, Z in the drawings represent the directions of the width, height, and depth of three-dimensional space assumed in the drawings. In FIGS. 1 and 2, the circle at the intersection of the arrows in the directions of X and Y indicates that the direction of Z is vertical downward of the drawing.

The image forming apparatus 1 is an apparatus that forms an image configurated of developer on a sheet 9 which is an example of a recording medium. The image forming apparatus 1 in the first exemplary embodiment is implemented as a printer that forms an image corresponding to image information obtained from an external device such as an information terminal, for instance.

As illustrated in FIG. 1, in the internal space of a housing 10, the image forming apparatus 1 includes an image former 2 that forms an unfixed image including developer based on the image information; an intermediate transfer unit 3 that secondarily transfers the unfixed image formed by the image former onto a sheet 9 which is temporarily held; a paper feeder 4 that stores and supplies the sheet 9 to be supplied to a position at which secondary transfer is performed by the intermediate transfer unit 3; a fixing unit 5 that fixes the unfixed image secondarily transferred by the intermediate transfer unit 3 onto the sheet 9; and a sheet separator 6 that separates the sheet 9 after the secondary transfer by the intermediate transfer unit 3 is completed.

The image information is, for instance, information related to an image, such as a character, a figure, a photograph, and a pattern. The dashed dotted line in FIG. 1 indicates the principal transport path when the paper sheet 9 is transported in the housing 10. The housing 10 is a structure that is formed in a desired shape with various support members, and exterior materials. In part of the upper surface of the housing 10, a discharge storage 12 that stores the sheets 9 discharged after an image is formed in a stacked state, and a paper exit outlet 13 through which the sheet 9 is discharged to the discharge storage 12 are formed.

The image former 2 is a unit that forms a toner image which is an unfixed image configurated of toner as the developer. The image former 2 in the first exemplary embodiment includes four image formers 2Y, 2M, 2C, and 2K that exclusively form respective toner images of four colors: yellow (Y), magenta (M), cyan (C), and black (K).

The four image formers 2 (Y, M, C, K) each have a photoconductor drum 21 that is a photoconductor which rotates in the direction indicated by an arrow A. In the periphery of the photoconductor drum 21, a charging device 22, an exposure device 23, a developing device 24 (Y, M, C, K), a first transfer device 25, and a drum cleaning device 26 are disposed. In FIG. 1, symbols 21 to 26 are denoted only for the image former 2K for black (K), and only part of the symbols 21 to 26 are denoted for the image formers 2 (Y, M, C) for other colors.

Among these devices, the charging device 22 is a device that charges the outer circumferential surface (surface where an image may be formed) of the photoconductor drum 21. The exposure device 23 is a device that performs exposure based on the image information to form an electrostatic latent image having a desired color component (Y,M,C,K) on the outer circumferential surface of the photoconductor drum 21. The developing device 24 (Y, M, C, K) is a device that develops and actualizes the electrostatic latent image formed on the outer circumferential surface of the photoconductor drum 21 with developer (toner) of a corresponding desired color (Y,M,C,K). The first transfer device 25 is a device that transfers a toner image of each color to an intermediate transfer unit 3 (an intermediate transfer belt 31). The drum cleaning device 26 is a device that cleans the photoconductor drum 21 by removing undesirable substances, such as toner, paper dust, adhering to the outer circumferential surface of the photoconductor drum 21. In the image formers 2 (Y, M, C, K), each portion at which the photoconductor drum 21 and the first transfer device 25 are opposed to each other provides a first transfer position at which a toner image is first transferred.

The intermediate transfer unit 3 is a unit that first transfers a toner image of each color formed by the image formers 2 (Y, M, C, K), holds the toner image, then transports the toner image, and secondarily transfers the toner image to the sheet 9 finally. The intermediate transfer unit 3 in the first exemplary embodiment is disposed on the upper side of the image formers 2 (Y, M, C, K) inside the housing 10. Specifically, the intermediate transfer unit 3 includes an intermediate transfer belt 31 which is an example of an image carrying unit or an image carrying belt that holds an unfixed toner image transferred from each photoconductor drum 21 in the image formers 2 (Y, M, C, K). In the periphery of the intermediate transfer belt 31, the following devices are disposed.

First, multiple support rollers 32a to 32e are disposed inwardly of the intermediate transfer belt 31. The intermediate transfer belt 31 is supported by the multiple support rollers 32a to 32e so as to sequentially pass through each first transfer position of the image formers 2 (Y, M, C, K) and to rotate (circumferentially move) in the direction indicated by an arrow B. Among these rollers, the support roller 32a is formed as a driving roller and a secondary transfer backup roller. In addition, the support roller 32b is formed as a tension roller, and the support roller 32e is formed as a cleaning backup roller of the later-described belt cleaning device (36).

Also, the above-mentioned first transfer device 25 in each of the image formers 2 (Y, M, C, K) is disposed inwardly of the intermediate transfer belt 31. The first transfer device 25 configurates part of the intermediate transfer unit 3, and the intermediate transfer belt 31 is pressed against the photoconductor drum 21 by a roller-shaped first transfer member to which a first transfer current is supplied. On the outer circumferential surface supported by the support roller 32a of the intermediate transfer belt 31, a second transfer device 35 is disposed which causes the sheet 9 to pass, and secondarily transfers a toner image on the intermediate transfer belt 31 onto the sheet 9. The second transfer device 35 presses the sheet 9 against an outer circumferential surface and causes the sheet 9 to pass by a roller-shaped second transfer member to which a second transfer current is supplied, the outer circumferential surface being supported by the support roller 32a of the intermediate transfer belt 31. In the intermediate transfer unit 3, the portion at which the second transfer device 35 is in contact with the outer circumferential surface of the intermediate transfer belt 31 provides a second transfer position TP2 at which a toner image is secondarily transferred.

Furthermore, in the periphery of the intermediate transfer belt 31, a belt cleaning device 36 is disposed which cleans the intermediate transfer belt 31 by removing undesirable substances, such as toner, remaining on the outer circumferential surface of the intermediate transfer belt 31 after the second transfer. The belt cleaning device 36 is formed by disposing inside the housing 36a a plate-like cleaning member 36b that is pressed against the outer circumferential surface of the intermediate transfer belt 31, and a collection member 36c that rotates and collects undesirable substances removed by the cleaning member 36b.

The sheet separator 6 separates the sheet 9 after completion of second transfer in the intermediate transfer unit 3 from the intermediate transfer belt 31. The details of the sheet separator 6 will be described later.

The paper feeder 4 stores and supplies the sheet 9 to be supplied to the position TP2 at which second transfer performed by the intermediate transfer unit 3. The paper feeder 4 in the first exemplary embodiment is disposed at a position on the lower side of the image formers 2 (Y, M, C, K) inside the housing 10. Specifically, the paper feeder 4 is formed by disposing a sheet storage body 41, and a supply device 43.

Among these, the sheet storage body 41 has a loading plate 42 that loads and stores multiple sheets 9 in a desired direction. The sheet storage body 41 is a storage member attached to allow an operation of drawing to the outside of the housing 10. The supply device 43 is a device that delivers the uppermost one of the sheets 9 by multiple rollers at a time, the sheets 9 being loaded on the loading plate 42 of the sheet storage body 41.

The fixing unit 5 is a unit that fixes a toner image secondarily transferred by the intermediate transfer part 3 onto the sheet 9. The fixing unit 5 in the first exemplary embodiment is disposed at a position on the upper side of the second transfer position TP2 of the intermediate transfer unit 3 inside the housing 10. Specifically, the fixing unit 5 is formed by disposing devices, such as a rotating body 51 for heating and a rotating body 52 for pressure in the internal space of the housing 50 provided with a feed inlet and a discharge outlet for the sheet 9.

Among these, the rotating body 51 for heating is part of a roller-shaped fixing unit that rotates in the direction indicated by an arrow. The rotating body 51 for heating is heated by a source of heat which is not illustrated so as to be maintained at a desired temperature. The rotating body 52 for pressure is part of a roller-shaped fixing unit that comes into contact with the rotating body 51 for heating under a desired pressure and is driven to rotate. In the fixing unit 5, the portion at which the rotating body 51 for heating and the rotating body 52 for pressure are in contact with each other provides a nip part (fixing processor) FN that heats and pressurizes the sheet 9, onto which an unfixed toner image is transferred, for fixing.

As illustrated in FIG. 1, the image forming apparatus 1 is provided with a paper feed transport path Rt1 between the paper feeder 4 and the second transfer position TP2 of the intermediate transfer unit 3 for transporting the sheet 9 in the paper feeder 4 to the second transfer position TP2. As illustrated in FIGS. 1 and 2, the paper feed transport path Rt1 is formed by disposing a pair of transport rollers 44 that interpose and transport the sheet 9, and multiple guidance members 45a, 45b that secure transport space for the sheet 9 and guide transport of the sheet 9. Among these, the transport rollers 44 are formed as registration rollers that correct skew of the sheet 9 and deliver the sheet 9 at a desired timing.

As illustrated in FIG. 1, the image forming apparatus 1 is provided with a guidance transport path Rt2 which is between the second transfer position TP2 of the intermediate transfer unit 3 and the nip part FN of the fixing unit 5 to guide the sheet 9 after completion of the second transfer to the nip part FN. As illustrated in FIG. 2, the guidance transport path Rt2 is formed by disposing multiple guidance members 46a, 46b, and 56 that secure transport space for the sheet 9 and guide transport of the sheet 9. Among these, the guidance member 56 is a guidance member for feed provided in the feed inlet of the housing 50 of the fixing unit 5. Here, a dashed dotted line VL illustrated in FIG. 2 indicates an ideal transport path for the sheet 9 in the guidance transport path Rt2. The dashed dotted line VL is an imaginary line obtained by connecting a cross-point CP1 and a cross-point CP2, the cross-point CP1 being the intersection between the nip part at the second transfer position TP2 and the line connecting a rotational center C1 of the support roller 32a of the intermediate transfer belt 31 and a rotational center C2 of the roller-shaped second transfer member of the second transfer device 35, the cross-point CP2 being the intersection between the nip part FN and the line connecting a rotational center C3 of the rotating body 51 for heating and a rotational center C4 of the rotating body 52 for pressure in the fixing unit 5.

Furthermore, as illustrated in FIG. 1, the image forming apparatus 1 is provided with a discharge transport path Rt3 between the fixing unit 5 and the paper exit outlet 13 for transporting the sheet 9 after completion of fixing to the paper exit outlet 13 and discharging the sheet 9 to the discharge storage 12. The discharge transport path Rt3 is formed by disposing a pair of discharge rollers 47 immediately before the paper exit outlet 13, and a guidance member (not illustrated) that secures transport space for the sheet 9 and guides transport of the sheet 9.

The image forming apparatus 1 performs the following basic image forming operations.

First, when a control unit (not illustrated) of the image forming apparatus 1 receives a command requesting an image forming operation from an external connection device or the like, relevant parts in the image formers 2, the intermediate transfer unit 3, the paper feeder 4, and the fixing unit 5 start at a predetermined timing. Here, an example of an operation when a color image, so-called a full-color image is formed will be described, the full-color image being constituted by combining toner images of the four colors (Y, M, C, K) formed by operating all the four image formers 2 (Y, M, C, K).

In the image formers 2 (Y, M, C, K), as illustrated in FIG. 1, each photoconductor drum 21 starts to rotate in the direction indicated by the arrow A, each charging device 22 charges the outer circumferential surface of the photoconductor drum 21 to a desired potential, then each exposure device 23 radiates light corresponding to an image-processed signal to the outer circumferential surface of the photoconductor drum 21 after being charged, and forms an electrostatic latent image having color components corresponding to the four colors. Subsequently, each developing device 24 (Y, M, C, K) develops the electrostatic latent image by supplying toner of a corresponding color (one of Y, M, C, and K) to cause the toner to adhere to the electrostatic latent image by an electrostatic action. Consequently, a toner image of a color corresponding to the electrostatic latent image is formed on the outer circumferential surface of each photoconductor drum 21. In the image formers 2 (Y, M, C, K), each drum cleaning device 26 cleans the outer circumferential surface of the photoconductor drum 21 over a period after the first transfer.

Subsequently, in the intermediate transfer unit 3, when the intermediate transfer belt 31 rotates in the direction indicated by the arrow B, and passes through the first transfer position of each of the image formers 2 (Y, M, C, K), each first transfer device 25 sequentially first transfers a toner image of a color on the outer circumferential surface of a corresponding photoconductor drum 21 in the image formers 2 (Y, M, C, K) onto the outer circumferential surface of the intermediate transfer belt 31. Since the intermediate transfer belt 31 rotates, the toner image first transferred onto the outer circumferential surface of the intermediate transfer belt 31 is transported to the second transfer position TP2.

Meanwhile, in the paper feeder 4, the supply device 43 supplies the sheet 9 stored in the sheet storage body 41 to the second transfer position TP2 in the intermediate transfer unit 3 on timing of a second transfer operation in the intermediate transfer unit 3. In this process, the sheet 9 delivered from the sheet storage body 41 of the paper feeder 4 by the supply device 43 is transported along the paper feed transport path Rt1 to the transport rollers 44 serving as the registration rollers, then is sent to the second transfer position TP2 at a desired timing by the transport rollers 44.

Subsequently, in the intermediate transfer unit 3, the second transfer device 35 secondarily transfers toner images first transferred and held on the outer circumferential surface of the intermediate transfer belt 31 collectively onto the sheet 9 supplied to the second transfer position TP2. Also in the intermediate transfer unit 3, the belt cleaning device 36 cleans the outer circumferential surface of the intermediate transfer belt 31 over a period after the second transfer.

Subsequently, the sheet 9 onto which a toner image has been transferred in the intermediate transfer unit 3 is sent from the second transfer position TP2 to the fixing unit along the guidance transport path Rt2. In this process, after the sheet 9 is passed through the second transfer position TP2, the sheet separator 6 separates from the outer circumferential surface of the intermediate transfer belt 31 the sheet 9 which has not been sufficiently or completely separated from the intermediate transfer belt 31.

In the fixing unit 5, the sheet 9 carrying a toner image is introduced to and passed through the nip part FN at which the rotating body 51 for heating and the rotating body 52 for pressure are in contact by pressure. Consequently, the toner image on the sheet 9 is heated under pressure in the nip part FN, melted, and fixed on the sheet 9 finally.

Lastly, the sheet 9 after completion of fixing is discharged from the fixing unit 5, then transported through the discharge transport path Rt3, and is stored in the discharge storage 12. In this process, the sheet 9 discharged from the fixing unit 5 is sent to the discharge rollers 47 along the discharge transport path Rt3, then is delivered to the outside of the housing 10 by the discharge rollers 47 through the paper exit outlet 13. Consequently, the sheet 9 after completion of fixing falls and is stored in the discharge storage 12.

The series of operations above are performed, and thus a full-color image is formed on one side of a sheet of paper 9, and the basic image forming operation is completed. In addition, with the image forming apparatus 1, it is possible to form a single color image by performing an image forming operation by operating one of the image formers 2 (Y, M, C, K), and to form a color image other than a full-color image by performing an image forming operation by operating two or three of the image formers 2 (Y, M, C, K).

<Failure in Sheet Separator>

In the image forming apparatus 1 described above, when the sheet separator 6 is not provided, the following failure may occur.

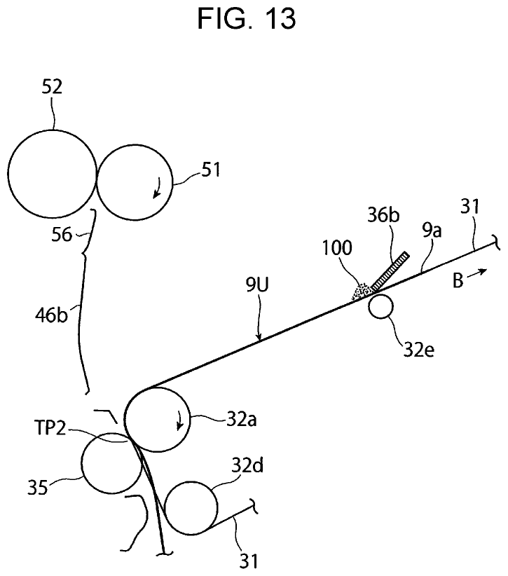

For instance, when image forming is performed using thin paper, as the sheet 9, which does not meet the recommended conditions in the specifications of the image forming apparatus 1, the following failure may occur. In this case, as illustrated in FIG. 13, after completion of the second transfer, a thin paper sheet 9U is not separated from the intermediate transfer belt 31, is transported with adhering to the intermediate transfer belt 31, and finally a front portion including a leading end 9a of the sheet 9U may enter the belt cleaning device 36 that is present on the downstream side of the second transfer position TP2 in a rotation direction B of the intermediate transfer belt 31. The sheet 9U then is pressed against the intermediate transfer belt 31 and interposed by the plate-like cleaning member 36b in the belt cleaning device 36. Thus, in this case, a problem occurs, for instance, it is hard to pull the sheet 9U out from the belt cleaning device 36, which makes it difficult to perform removal processing, or when the sheet 9U is pulled out, undesirable substances 100, such as toner, removed and collected by the belt cleaning device 36 may adhere to the sheet 9U which is contaminated, or when the sheet 9U is pulled out from the belt cleaning device 36, the adhering toner may be scattered, and the inside of the image forming apparatus 1 is contaminated.

Although the sheet separator 6 is provided in the image forming apparatus 1, another new problem may occur even in this situation.

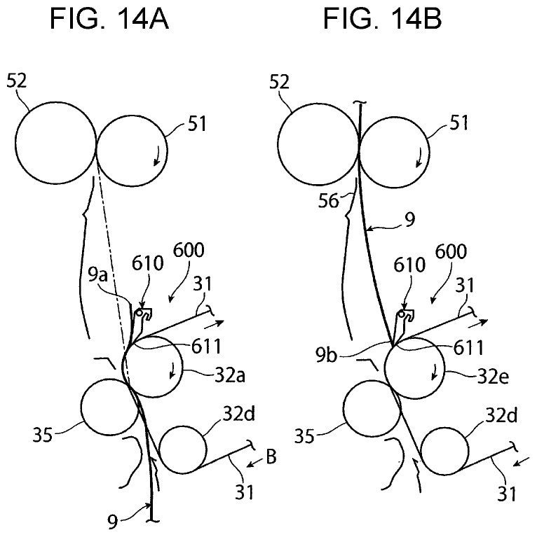

Specifically, when a sheet separator 600 including only a contact separation claw 610, in which a tapered leading end 611 is provided in contact with the outer circumferential surface of the intermediate transfer belt 31, is disposed as the sheet separator 6 as illustrated in FIGS. 14A and 14B, the following may occur. First, when the sheet separator 600 is provided, even when image forming is performed using the thin paper sheet 9U as the sheet 9, after completion of the second transfer, the thin paper sheet 9U is separated from the intermediate transfer belt 31 or passing of the thin paper sheet 9U is prevented by the contact separation claw 610 in the sheet separator 600. Therefore, entering of the front portion of the thin paper sheet 9U then into the belt cleaning device 36 as described above is prevented.

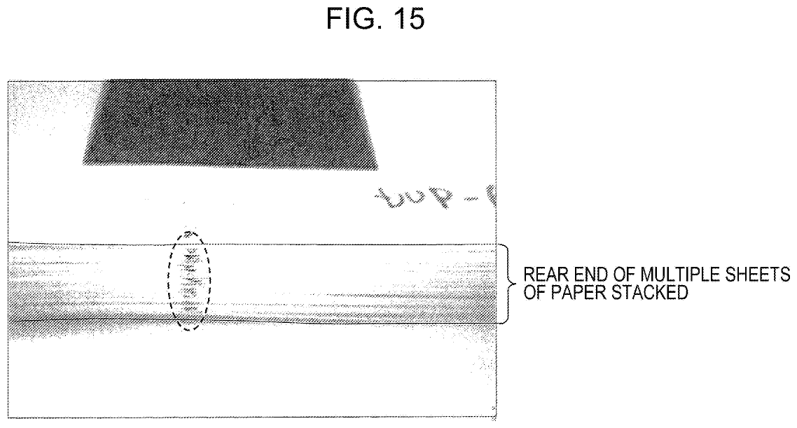

However, in this case, the leading end 611 of the contact separation claw 610 in the sheet separator 600 may be contaminated by residual toner adhering to the leading end 611, the residual toner remaining after transfer on the intermediate transfer belt 31. Thus, when the sheet 9 after completion of the second transfer moves passing the second transfer position TP2, contact of a rear end 9b of the sheet 9 with the leading end 611 of the contact separation claw 610 causes a problem that the remaining toner after transfer at the leading end 611 of the contact separation claw 610 adheres to the rear end 9b which is contaminated. Such dirt due to toner at the rear end 9b of the sheet is recognized as noticeable dirt as indicated in the range surrounded by a dotted line in FIG. 15 when multiple sheets 9 for which image forming is completed are stacked in a bundle.

<Detailed Configuration of Sheet Separator>

Thus, in the image forming apparatus 1, the sheet separator 6 having the following configuration is provided at a position passing the second transfer position TP2 of the intermediate transfer belt 31 in the intermediate transfer unit 3.

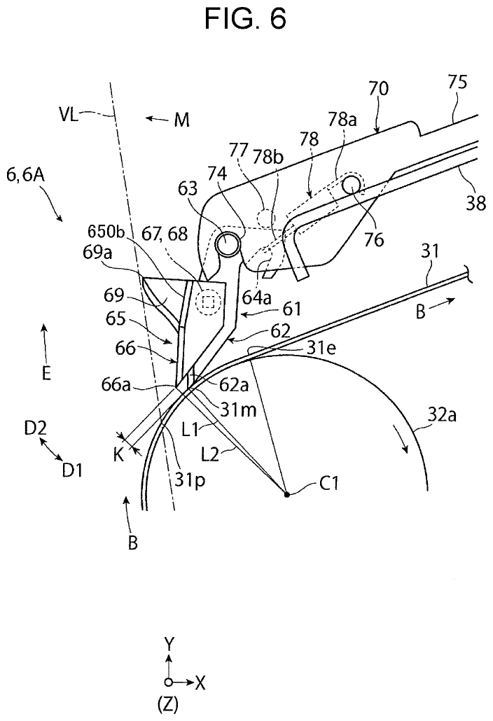

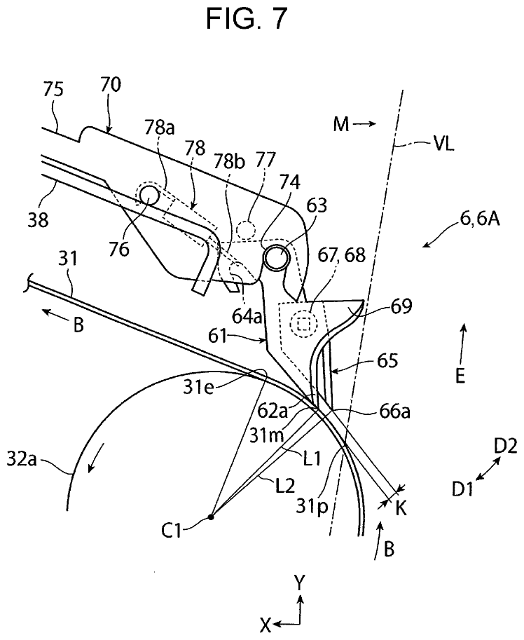

As illustrated in FIGS. 2 to 7, the sheet separator 6 includes a first separating unit 61 that separates the sheet 9 after completion of the second transfer from the intermediate transfer belt 31 with a leading end 62 of the first separating unit 61 in contact with the outer circumferential surface of the intermediate transfer belt 31, and a second separating unit 65 that separates the sheet 9 after completion of the second transfer from the intermediate transfer belt 31 with a leading end 66 of the second separating unit 65 not in contact with the outer circumferential surface of the intermediate transfer belt 31. As illustrated in FIGS. 6 and 7, (a leading end 66a of) the leading end portion 66 of the second separating unit 65 is disposed at a position on the upstream side of (a leading end 62a of) the leading end portion 62 of the first separating unit 61 in the rotation direction B of the intermediate transfer belt 31.

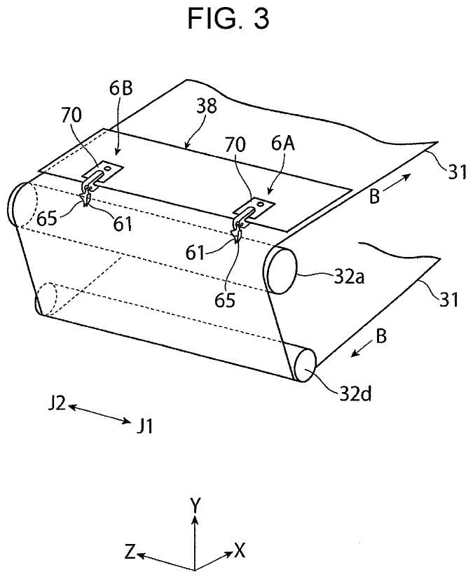

As illustrated in FIGS. 2 and 3, multiple sheet separators 6 are provided with a desired interval between the multiple sheet separators in the width direction (the direction of the rotation axis of the support roller 32a) J of the intermediate transfer belt 31. In the first exemplary embodiment, two sheet separators 6A, 6B are provided. Hereinafter, a description regarding the sheet separator 6 is for the two sheet separators 6A, 6B unless otherwise clearly stated.

As illustrated in FIGS. 2, 4A, 4B, and 6, in the sheet separator 6, the first separating unit 61 is mounted on the fixed frame 70 as a support unit with a support shaft 63 as a fulcrum with capable of being swung in the directions indicated by arrows D1, D2, and the second separating unit 65 is mounted on and fixed to the first separating unit 61. At this point, as illustrated in FIG. 6, the first separating unit 61 is urged by an urging unit 78 so as to maintain a state where the first separating unit 61 continues to swing in the direction indicated by an arrow D1. Consequently, when the first separating unit 61 is used, the leading end portion 62 comes into contact with the outer circumferential surface of the intermediate transfer belt 31 stably. As the urging unit 78, for instance, a coil-like tension spring is applied.

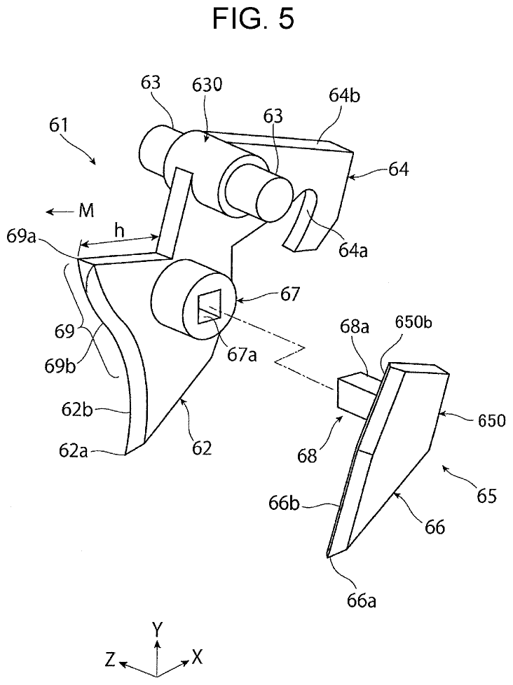

As illustrated in FIG. 5, the first separating unit 61 in the sheet separator 6 is formed as a member having an axial section 630 provided with the support shaft 63, the taper-shaped leading end portion 62 that extends in one direction from the axial section 630, and an arm section 64 in a shape extending in an inflection direction relative to the extending direction of the leading end portion 62 from the axial section 630. Among these, an opposed portion 62b of the leading end portion 62, facing the separated sheet 9 is in an edge shape having a cross-section in a tapered shape toward the sheet 9 from the viewpoint of reducing the contact area when the sheet 9 is in contact.

As illustrated in FIG. 5, the first separating unit 61 is provided with a first coupling portion 67 to be coupled to the second separating unit 65 at a position on one surface side between the leading end 62a of the leading end portion 62 and the support shaft 63. The first coupling portion 67 is formed as a cylindrical structure provided with a rectangular cross-sectional coupling hole 67a, for instance. As illustrated in FIG. 5, the first separating unit 61 is provided with a groove-shaped hook section 64a for hooking a mounting section 78b at one end of the urging unit 78 to the arm section 64. The hook section 64a is formed as a recessed section that cuts in diagonally upward from a lower position of one end of the arm section 64.

Furthermore, as illustrated in FIGS. 5 and 6, the first separating unit 61 is provided with a projection guidance unit 69, as an example of a guiding unit, that guides the sheet 9 separated by the second separating unit 65 in a direction M in which the sheet 9 is away from the second separating unit 65. In the portion (the portion near the axial section 630) on the rear side of the leading end portion 62 of the first separating unit 61, the projection guidance unit 69 is formed as a portion in a shape that gradually projects in the direction M in which the sheet 9 is away from the second separating unit 65 on more downstream side of a transport path E for the sheet 9. As illustrated in FIG. 6, the projection guidance unit 69 is formed so that the height (the distance away from the second separating unit 65) h of the most projecting vertex 69a away from the second separating unit 65 has a value comparable to reach a position close to the ideal transport path VL for the sheet 9 in the guidance transport path Rt2, for instance. Similarly to the case of the leading end portion 62 in the first separating unit 61, an opposed portion 69b of the projection guidance unit 69, facing the separated sheet 9 is in an edge shape having a cross-section in a tapered shape toward the sheet 9.

In contrast, the second separating unit 65 in the sheet separator 6 is formed as a member having the leading end portion 66 in a tapered shape, and a main body 650 in a shape extending to the rear side of the leading end portion 66. Similarly to the case of the leading end portion 62 in the first separating unit 61, the leading end portion 66 and opposed portions 66b, 650b of the main body 650, facing the separated sheet 9 are each in an edge shape having a cross-section in a tapered shape toward the sheet 9.

The second separating unit 65 is provided with a second coupling portion 68 to be coupled to the first coupling portion 67 in the first separating unit 61 at a substantially central position on one surface side of the main body 650. The second coupling portion 68 is formed as a rectangular cross-sectional projection coupling shaft 68a which is inserted in and fixed to a coupling hole 67a of the first coupling portion 67 in the first separating unit 61, for instance. The second separating unit 65 adjusts and sets the shape and size of the second coupling portion 68 and the first coupling portion 67 in the first separating unit 61, thereby determining the mounting condition and the positional relationship with the first separating unit 61.

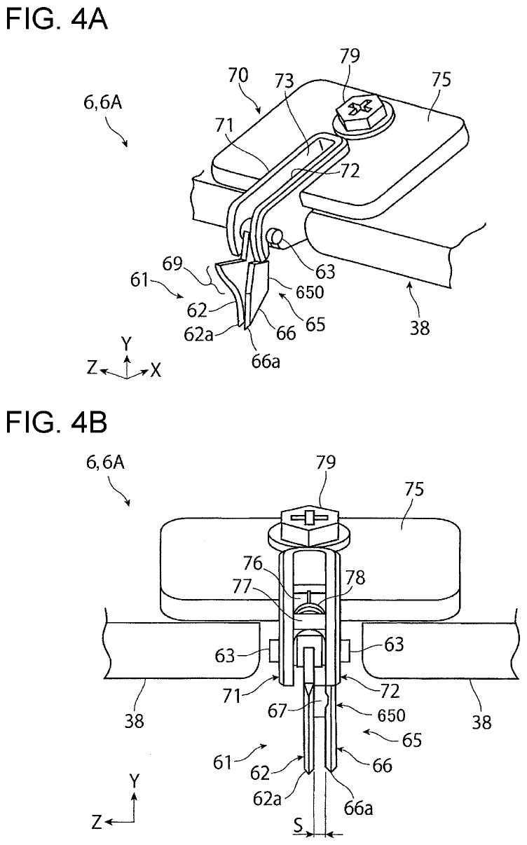

As illustrated in FIGS. 4A, 4B, and 6, the fixed frame 70 in the sheet separator 6 is a member in a shape having opposed faces 71, 72 opposed to each other with a desired interval therebetween to secure gap space 73, and a plate-like mounting face 75 that is disposed and connected at the rear portion of a fixing side of the opposed faces 71, 72.

Among these, the end on the side opposite to the mounting face 75 of the opposed faces 71, 72 is provided with a bearing recessed section 74 which receives and rotatably holds the support shaft 63 of the first separating unit 61 as illustrated in FIGS. 6 and 7. The bearing recessed section 74 is formed as a recessed section that cuts in diagonally upward from a lower position of one end of the opposed faces 71, 72. In the portion at the end side opposite to the end, where the bearing recessed section 74 is provided, of the opposed faces 71, 72, a rod-like hook section 76 is provided which traverses the gap space 73. In addition, the portion between the bearing recessed section 74 of the opposed faces 71, 72 and the hook section 76 is provided with a swing stopper 77 that regulates and stops the swing of the first separating unit 61 in the direction indicated by the arrow D1. The swing stopper 77 is disposed at a position where the swing stopper 77 is in contact with an upper surface section (back section) 64b of the arm section 64 of the first separating unit 61. The swing stopper 77 prevents the leading end 62a of the leading end portion 62 of the first separating unit 61 from entering more than necessary and coming into contact with the outer circumferential surface of the intermediate transfer belt 31.

As illustrated in FIGS. 2 and. 4, the mounting face 75 of the fixed frame 70 is mounted on and fixed to the mounting position of a mounting plate 38 disposed on the downstream side of the second transfer position TP2 of the intermediate transfer unit 3. The mounting face 75 is fixed to the mounting plate 38 by a fixing unit 79 such as a fixing screw. The mounting plate 38 is mounted on and disposed at a support frame (not illustrated) for mounting the support roller 32a, the belt cleaning device 36 in the intermediate transfer unit 3.

The sheet separator 6 is assembled, for instance, in the following manner.

First, as illustrated in FIGS. 4A, 4B, and 6, the support shaft 63 of the first separating unit 61 is inserted in the bearing recessed section 74 of the opposed faces 71, 72 of the fixed frame 70. Subsequently, as illustrated in FIGS. 6 and 7, the tension spring serving as the urging unit 78 is mounted such that a mounting section 78a at one end of the tension spring is hooked on the rod-like hook section 76 in the opposed faces 71, 72 of the fixed frame 70, and the mounting section 78b at the other end is hooked on the groove-shaped hook section 64a in the arm section 64 of the first separating unit 61.

Consequently, as illustrated in FIG. 6, the first separating unit 61 is mounted swingably in the directions indicated by the arrows D1, D2 in the fixed frame 70 with the support shaft 63 serving as a fulcrum, and the first separating unit 61 is mounted with urged to continue to swing in the direction indicated by the arrow D1 by the tension spring serving as the urging unit 78. In this situation, the upper surface section 64b of the arm section 64 of the first separating unit 61 comes into contact with the swing stopper 77 in the opposed faces 71, 72 of the fixed frame 70, and is stopped. Then, the first separating unit 61 is maintained at a non-swingable state any further in the direction indicated by the arrow D1.

Subsequently, for the second separating unit 65, as illustrated in FIG. 5, the second coupling portion 68 is coupled and fixed to the first coupling portion 67 in the first separating unit 61. The coupling in this situation is made by inserting the square rod-like coupling shaft 68a in the second coupling portion 68 into the rectangular cross-sectional coupling hole 67a in the first coupling portion 67.

Consequently, as illustrated in FIGS. 4A and 4B, the second separating unit 65 is mounted on and fixed to the first separating unit 61, which is mounted on the fixed frame 70. The second separating unit 65 in this situation is maintained at a stationary state relative to the first separating unit 61 and is mounted by coupling the second coupling portion 68 to the first coupling portion 67. Specifically, it may be said that the second separating unit 65 in this situation is provided in a state fixed to the first separating unit 61, and in other words, the second separating unit 65 is integrated with the first separating unit 61.

The second separating unit 65 in this situation has a relationship such that the leading end 66a of the leading end portion 66 is present at a position away from the leading end 62a of the leading end portion 62 of the first separating unit 61 by a certain spacing distance in a swinging direction, indicated by the arrow D2, of the first separating unit 61. When the sheet separator 6 is actually used, the spacing distance in this situation corresponds to the spacing distance (floating amount) between the leading end 66a of the leading end portion 66 of the second separating unit 65 and the outer circumferential surface of the intermediate transfer belt 31. The spacing distance may be set to a desired value by changing the shape or the size of the leading end portion 66 of the second separating unit 65, and the coupling state between the first coupling portion 67 and the second coupling portion 68 as appropriate.

Furthermore, as illustrated in FIG. 4B, the leading end portion 66 of the second separating unit 65 in this situation is disposed to have a positional relationship with the leading end portion 62 of the first separating unit 61 so as to be spaced by a desired interval S (in the width direction J of the intermediate transfer belt 31]). The interval S in this situation may be set by changing, for instance, the size and the shape of the first coupling portion 67 in the first separating unit 61 and the second coupling portion 68 in the second separating unit 65 as appropriate.

Consequently, as illustrated in FIG. 4, in the sheet separator 6, the first separating unit 61 and the second separating unit 65 are mounted on the fixed frame 70, and assembly is completed. As described above, for the sheet separator 6 in the first exemplary embodiment, two sheet separators 6A and 6B are assembled and prepared.

As illustrated in FIG. 3, the two sheet separators 6A and 6B as the sheet separator 6 are mounted and usable by fixing the mounting face 75 in the fixed frame 70 to two predetermined mounting positions of the mounting plate 38 in the intermediate transfer unit 3 using the fixing unit 79.

Preferably, as illustrated in FIG. 3, for the two sheet separators 6A, 6B, the second separating unit 65 is disposed at a position outwardly of the first separating unit 61 in the width direction (or the direction of the rotation axis of the support roller 32a) J of the intermediate transfer belt 31. In this case, the sheet separator 6A disposes the second separating unit 65 at a position (outward position) on the downstream side of the first separating unit 61 in the direction indicated by the width direction J1 of the intermediate transfer belt 31. Also, the sheet separator 6B disposes the second separating unit 65 at a position (outward position) on the downstream side of the first separating unit 61 in the direction indicated by the width direction J2 of the intermediate transfer belt 31.

When the sheet separator 6 is mounted on the mounting plate 38 in the intermediate transfer unit 3, as illustrated in FIGS. 6 and 7, the leading end portion 62 of the first separating unit 61 is in a contact state with a predetermined position 31m on the outer circumferential surface of the intermediate transfer belt 31, and the leading end portion 66 of the second separating unit 65 is not in contact state (a non-contact state or a floating state) with the outer circumferential surface of the intermediate transfer belt 31. In this case, the spacing distance (floating amount) K between the leading end portion 66 of the second separating unit 65 and the outer circumferential surface of the intermediate transfer belt 31 is automatically determined by bringing the leading end portion 62 of the first separating unit 61 into contact with the outer circumferential surface of the intermediate transfer belt 31 because the second separating unit 65 is mounted on and fixed to the first separating unit 61 as described above, and the positional relationship with the components of the first separating unit 61 is maintained at constant. The spacing distance K for the leading end portion 66 of the second separating unit 65 is set, for instance, within a range of 0.5 to 5.0 mm, and is preferably set within a range of 0.5 to 3.0 mm. In this case, the first separating unit 61 is urged by the urging unit 78 so as to swing in the direction indicated by the arrow D1, thus the leading end 62a of the leading end portion 62 is maintained at a state in contact with the intermediate transfer belt 31 by a desired pressure.

Moreover, as illustrated in FIGS. 6 and 7, in the sheet separator 6 in this situation, the leading end 66a of the leading end portion 66 of the second separating unit 65 is present at a position on the upstream side of the leading end 62a of the leading end portion 62 of the first separating unit 61 in the rotation direction B of the intermediate transfer belt 31. Specifically, as illustrated in FIGS. 6 and 7, the leading end 66a of the leading end portion 66 in the second separating unit 65 is disposed so that a line L2 is displaced to the upstream side of a line L1 in the rotation direction B of the intermediate transfer belt 31, the line L2 connecting the leading end 66a and the rotational center C1 of the support roller 32a of the intermediate transfer belt 31, the line L1 connecting the leading end 62a of the leading end portion 62 in the first separating unit 61 and the rotational center C1 of the support roller 32a of the intermediate transfer belt 31. A displacement amount (the spacing distance in the rotation direction B) when the leading end 66a of the leading end portion 66 is displaced from the leading end 62a of the leading end portion 62 is set, for instance, within a range greater than 0 mm and less than or equal to 5 mm, and preferably, within a range less than or equal to 3 mm.

As illustrated in FIGS. 6 and 7, for the position 31m at which the leading end portion 62 of the first separating unit 61 is brought into contact with the outer circumferential surface of the intermediate transfer belt 31, the sheet separator 6 is set to a range from a position at which the second transfer position TP2 is exited to a position 31e at a terminal point of winding in a range in which the intermediate transfer belt 31 is wound around the support roller 32a. Particularly, in the sheet separator 6, as illustrated in FIGS. 6 and 7, the leading end portion 66 of the second separating unit 65 is disposed at a position on the downstream side, in the rotation direction B of the intermediate transfer belt 31, of a position 31p at which the leading end 9a at the time of transport of the sheet 9 naturally starts to separate from the intermediate transfer belt 31. For instance, as illustrated in FIGS. 6 and 7, the position at which the intermediate transfer belt 31 crosses the ideal transport path VL may be applied to the position 31p at which the leading end 9a naturally starts to separate. Here, naturally starting to separate refers to that the sheet 9 starts to separate from the image carrying unit such as the intermediate transfer belt 31 without receiving assistance by the separating unit by itself or by its own strength.

<Function of Sheet Separator>

When an image forming operation is performed by the image forming apparatus 1, the sheet separator 6 (sheet separators 6A, 6B) functions as follows.

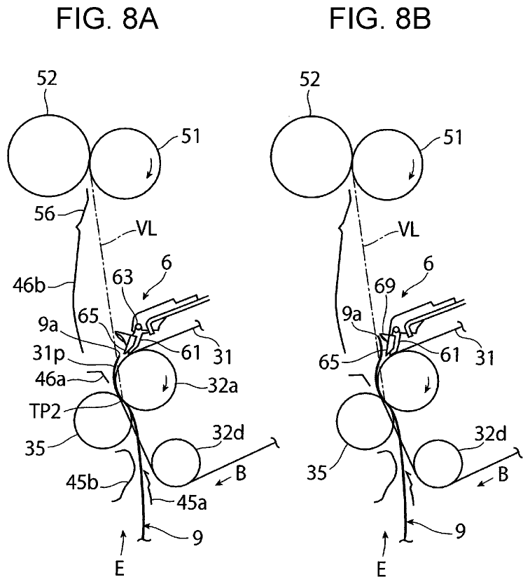

For instance, except for the case where the thin paper sheet 9U not meeting the above-mentioned recommended conditions in the specifications is used, as illustrated in FIG. 8A, the leading end 9a of the sheet 9, which has passed the second transfer position TP2 in the intermediate transfer unit 3, often naturally starts to separate from the intermediate transfer belt 31 at a position on the upstream side of the leading end portion 66 of the second separating unit 65 in the sheet separator 6 in the rotation direction B of the intermediate transfer belt 31.

In this case, the sheet 9 which starts to separate from the intermediate transfer belt 31 may pass without receiving a separating action by the sheet separator 6. However, when the sheet 9 comes into contact with the leading end portion 66 of the second separating unit 65 in the sheet separator 6, as illustrated in FIG. 8B, the sheet 9 comes into contact with (the opposed portion 66b of) the leading end portion 66 of the second separating unit 65, and moves so as to be guided. Thus, separation of the sheet 9 in this situation is assisted by the leading end portion 66 of the second separating unit 65, and the sheet 9 is favorably transported. In the sheet separator 6, the sheet 9 comes into contact with the leading end portion 66 of the second separating unit 65 and is guided slightly, then comes into contact with the projection guidance unit 69 in the first separating unit 61, and moves so as to be guided. Thus, the sheet 9 in this situation moves while being guided in a direction in which the sheet 9 is away from the second separating unit 65.

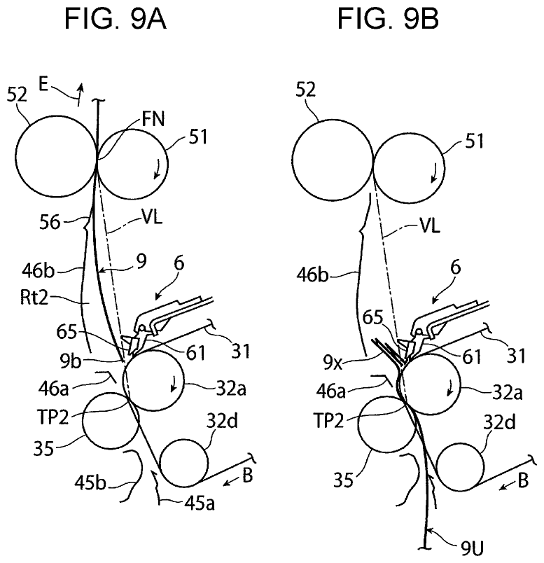

Subsequently, even after the leading end 9a of the sheet 9 passes the sheet separator 6, at the second transfer position TP2, the sheet 9 is interposed between the intermediate transfer belt 31 which rotates in the direction indicated by the arrow B and the second transfer device 35, proceeds along the guidance transport path Rt2 while obtaining transport force, and as partially illustrated in FIG. 9A, the leading end 9a is introduced to the nip part FN in the fixing unit 5. The sheet 9 in this situation is interposed between the rotating body 51 for heating and the rotating body 52 for pressure which rotates in the direction indicated by the arrow in the nip part FN of the fixing unit 5, and a transport force is thereby obtained and the sheet 9 is transported.

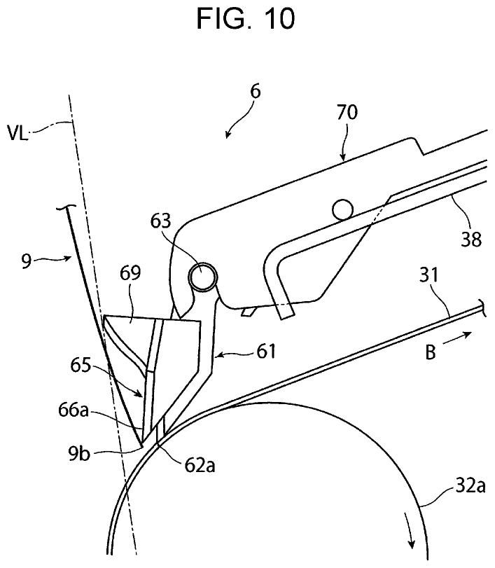

Subsequently, when the rear end 9b of the sheet 9 passes and exits the second transfer position TP2, as illustrated in FIG. 9A, particularly when an unfixed toner image is bent to curve and deformed (curled) on the surface onto which the second transfer is performed, the curled rear end 9b moves closer to the sheet separator 6. In this case, as illustrated in FIG. 10, the rear end 9b of the sheet 9 may once come into contact with the leading end portion 66 of the second separating unit 65 in the sheet separator 6, and may move.

However, in this case, as illustrated in FIG. 10, the leading end portion 66 of the second separating unit 65 is not in contact with the outer circumferential surface of the intermediate transfer belt 31, thus the residual toner remaining after transfer on the intermediate transfer belt 31 is scraped off, and the toner remaining after transfer does not adhere to the sheet 9. Consequently, even when the rear end 9b of the sheet 9 in this situation comes into contact with the leading end portion 66 of the second separating unit 65, the rear end 9b is not contaminated due to adherence of toner at the leading end portion 66.

Also in this case, even when the rear end 9b of the sheet 9 comes into contact with the leading end portion 66 of the second separating unit 65, the rear end 9b does not come into contact with the leading end portion 62 of the first separating unit 61 on the downstream side of the leading end portion 66 of the second separating unit 65 in the rotation direction B of the intermediate transfer belt 31. The leading end portion 62 of the first separating unit 61 may in contact with the outer circumferential surface of the intermediate transfer belt 31, and the residual toner remaining after transfer on the intermediate transfer belt 31 is scraped off, and the toner remaining after transfer may adhere to the leading end portion 62. Thus, as in the case where the rear end 9b of the sheet 9 in this situation comes into contact with the leading end portion 62 of the first separating unit 61, adherence of the toner at the leading end portion 62 to the rear end 9b does not occur.

Therefore, in the image forming apparatus 1 including the sheet separator 6, when an image forming operation is performed, adherence of toner at the leading end portion 62 of the first separating unit 61 to the rear end 9b of the sheet 9 used for the image forming operation and contamination of the rear end 9b are reduced.

In this respect, for instance, when the leading end portion 66 of the second separating unit 65 in the sheet separator 6 is disposed at a position on the downstream side of the leading end portion 62 of the first separating unit 61 in the rotation direction B of the intermediate transfer belt 31, the following problem may occur. Specifically, in the case where such disposition is made, the rear end 9b of the sheet 9 may come into contact with the leading end portion 62 of the first separating unit 61, thus the rear end 9b of the sheet 9 may be contaminated due to adherence of toner at the leading end portion 62 of the first separating unit 61 to the rear end 9b. Therefore, in this case, it is not possible to prevent contamination of the rear end 9b of the sheet 9 due to adherence of toner at the leading end portion 62 of the first separating unit 61 to the rear end 9b.

In the sheet separator 6, even when an image forming operation is performed using the thin paper sheet 9U not meeting the above-mentioned recommended conditions in the specifications, the leading end of the thin paper sheet 9U passes through the leading end portion 66 not in contact with the intermediate transfer belt 31 of the second separating unit 65. However, the thin paper sheet 9U is caught by the leading end portion 62 in contact with the intermediate transfer belt 31 of the first separating unit 61, and the thin paper sheet 9U starts to separate from the intermediate transfer belt 31. In this case, as illustrated in FIG. 9B, the path of the thin paper sheet 9U which starts to separate by the leading end portion 62 of the first separating unit 61 is blocked by the presence of the second separating unit 65, and as illustrated by symbol 9x in FIG. 9B, the thin paper sheet 9U is deformed and folded, and is jammed. In this case, the image forming operation is forced to be terminated, and the jammed thin paper sheet 9U is removed. However, in this case, non-separation of the thin paper sheet 9U from the intermediate transfer belt 31, transport of the thin paper sheet 9U sticking to the intermediate transfer belt 31, and entering of the thin paper sheet 9U into the belt cleaning device 36 (FIG. 13) are prevented. Thus, a removal operation of pulling the thin paper sheet 9U from the belt cleaning device 36 is not necessary.

In the sheet separator 6, the second separating unit 65 is provided in a state fixed to the first separating unit 61, and the second separating unit 65 is maintained at a stationary state relative to the first separating unit 61. Thus, the spacing distance K (the floating amount) between the leading end portion 66 of the second separating unit 65 and the intermediate transfer belt 31 is maintained stably with reference to the first separating unit 61 by bringing the leading end portion 62 of the first separating unit 61 into contact with the intermediate transfer belt 31. In the sheet separator 6, even when the first separating unit 61 swings very slightly around the support shaft 63 as a fulcrum, for instance, due to factors such as variation in a surface state and a rotational state of the intermediate transfer belt 31 and the support roller 32a, the second separating unit 65 is fixed to the first separating unit 61 and moves in coordination with (integrally with) swinging which is a movement of the first separating unit 61. Therefore, the positional relationship between the leading end portion 62 of the first separating unit 61 and the leading end portion 66 of the second separating unit 65 is stably maintained. Consequently, in the sheet separator 6, separation of the sheet 9 is stably performed by the leading end portion 66 of the second separating unit 65. The management and adjustment for maintaining the spacing distance K for the leading end portion 66 of the second separating unit 65 at a constant level is unnecessary.

In the sheet separator 6, the leading end portion 66 of the second separating unit 65 is disposed at a position on the downstream side, in the rotation direction B of the intermediate transfer belt 31, of a position 31p at which the leading end 9a of the sheet 9 naturally starts to separate from the intermediate transfer belt 31. Consequently, the leading end 9a of the sheet 9, which starts to separate, is likely to reach the leading end portion 66 of the second separating unit 65. Because of this, separation of the sheet 9 is stably performed by the leading end portion 66 of the second separating unit 65.

Furthermore, as illustrated in FIG. 4B, in the sheet separator 6, the leading end portion 62 of the first separating unit 61 and the leading end portion 66 of the second separating unit 65 are disposed with a desired interval S in the width direction J of the intermediate transfer belt 31. Thus, when the leading end portion 62 in contact with the intermediate transfer belt 31 of the first separating unit 61 scrapes off the toner remaining after transfer on the intermediate transfer belt 31, contamination of the second separating unit 65 due to floating and adherence of part of the toner is reduced.

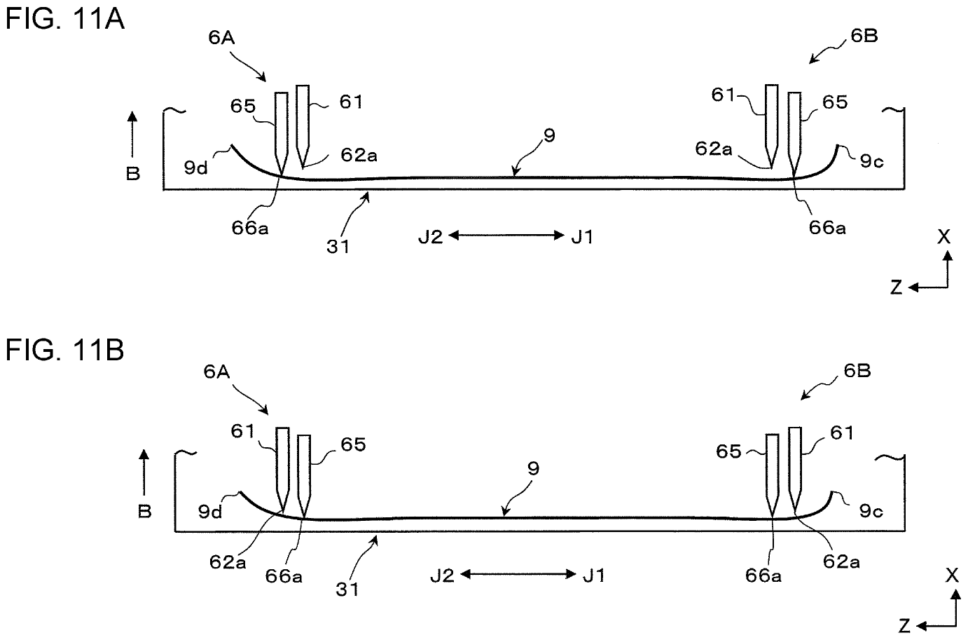

Particularly, in the sheet separators 6A, 6B as the sheet separator 6, as illustrated in FIG. 3, the second separating unit 65 is disposed at a position outwardly of the first separating unit 61 in the direction J of the rotation axis of the intermediate transfer belt 31. Thus, as illustrated in FIG. 11A, even when both ends 9c, 9d of the sheet 9, which naturally separates after passing the second transfer position TP2, in the width direction at the time of transport are transported such that an unfixed toner image by the second transfer is bent to curve and deformed on a surface, the rear end 9b of the sheet 9 first comes into contact with and is supported by the leading end portion 66 of the second transportation means 65. Thus, even with the sheet 9 in which both ends 9c, 9d are deformed, contact of the rear end 9b with the leading end 62a of the leading end portion 62 of the first separating unit 61 is avoided, contamination due to adherence of toner at the leading end portion 62 of the first separating unit 61 is prevented.

In this respect, for the sheet separators 6A, 6B, for instance, as illustrated in FIG. 11B, when the second separating unit 65 is disposed at a position inwardly of the first separating unit 61 in the direction J of the rotation axis of the intermediate transfer belt 31, the following problem may occur. Specifically, in the case where the sheet separator is configurated in this manner, when the sheet 9 is transported with the both ends 9c, 9d deformed to bend as described above, the rear end 9b of the sheet 9 may come into contact with the leading end portion 62 of the first separating unit 61 earlier than the leading end portion 66 of the second transportation means 65. Therefore, the rear end 9b of the sheet 9 in this situation is contaminated due to adherence of toner at the leading end 62a of the leading end portion 62 of the first separating unit 61 to the rear end 9b.

Furthermore, in the sheet separator 6, as illustrated in FIG. 6, the first separating unit 61 is provided with the projection guidance unit 69. Thus, as illustrated in FIG. 8B, the sheet 9, which comes into contact with the leading end portion 66 of the second separating unit 65 and is separated, is guided to move by the projection guidance unit 69 in a direction in which the sheet 9 is away from the second separating unit 65. Therefore, contact of the rear end 9b of the sheet 9 with the leading end portion 62 of the first separating unit 61 is reliably avoided, and contamination due to adherence of toner at the leading end portion 62 is likely to be reduced.

### Other Modifications

The present disclosure does not limit the contents illustrated in the first and second exemplary embodiments, and includes, for example, the modification presented below.

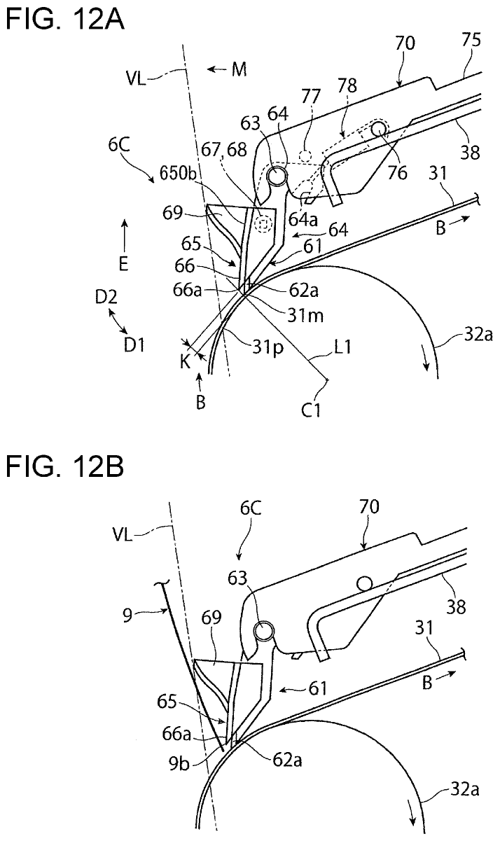

In the sheet separator 6, as illustrated in FIG. 12A, the leading end 66a of the leading end portion 66 of the second separating unit 65 may be disposed at the same position as the leading end 62a of the leading end portion 62 of the first separating unit 61 in the rotation direction B of the intermediate transfer belt 31.

In this case, the position at which the leading end 66a of the leading end portion 66 of the second separating unit 65 comes into contact with the intermediate transfer belt 31 is on the extended line of the line L1 connecting the rotational center C1 of the support roller 32a of the intermediate transfer belt 31 and the position 31m at which the leading end 62a of the leading end portion 62 of the first separating unit 61 is in contact with the intermediate transfer belt 31. Specifically, the position at which the leading end 66a of the second separating unit 65 is in contact with the intermediate transfer belt 31 is away from the position 31m at which the leading end 62a of the first separating unit 61 is in contact with the intermediate transfer belt 31 by a distance corresponding to the spacing distance K between the leading end 66a of the second separating unit 65 and the intermediate transfer belt 31.

In the sheet separator 6C in a modification including the first separating unit 61 and the second separating unit 65 which are disposed with this positional relationship, when the sheet 9 passes the sheet separator 6C, as illustrated in FIG. 12B, the rear end 9b first comes into contact with the leading end 66a of the leading end portion 66 in a non-contact state with the intermediate transfer belt 31 of the second separating unit 65, and the rear end 9b is unlikely to come into contact with the leading end 62a of the leading end portion 62 in a contact state with the intermediate transfer belt 31 of the first separating unit 61. Therefore, even with the sheet separator 6C in the modification, contamination of the rear end 9b of the sheet 9 used for an image forming operation due to adherence of toner at the leading end portion 62 of the first separating unit 61 is reduced.

In the sheet separator 6C in the modification, when the sheet extremely bent and deformed is passed with the rear end 9b of the sheet 9 curved on the side of a surface onto which an unfixed toner image is secondarily transferred, the deformed rear end 9b may come into contact with the leading end 62a of the leading end portion 62 of the first separating unit 61 by coming around the leading end portion 66 of the second separating unit 65. In this case, the rear end 9b of the sheet 9 is contaminated due to adherence of toner at the leading end portion 62 of the first separating unit 61.

In two sheet separators 6A, 6B, two pieces of one of the sheet separators 6A, 6B may be combined and disposed. In this situation, in each of the cases where two sheet separators 6A are disposed and where two sheet separators 6B are disposed, the second separating unit 65 in one of the sheet separators 6A, 6B is disposed at a position outwardly of the first separating unit 61 in the width direction (the direction of the rotation axis) J of the intermediate transfer belt 31, and the second separating unit 65 in the other of the sheet separators 6A, 6B is disposed at a position inwardly of the first separating unit 61 in the width direction J of the intermediate transfer belt 31. However, in this situation, in each of the cases where two sheet separators 6A or 6B are disposed, as illustrated in FIG. 11B, both of two second separating units 65 are not disposed at positions inwardly of the first separating unit 61 in the width direction J of the intermediate transfer belt 31. The same goes for the case where two sheet separators 6C in the modification are combined and disposed as the sheet separator 6.

Furthermore, the configuration in which the second separating unit 65 in the sheet separator 6 is provided to maintain at a stationary state relative to the first separating unit 61 is not limited to the configuration example in which the first coupling portion 67 and the second coupling portion 68 illustrated in the first exemplary embodiment are combined and integrated, and other configurations may be adopted. For instance, the configuration in which the second separating unit 65 is mounted in a state fixed to the support shaft 63 of the first separating unit 61, and the configuration in which the second separating unit 65 is mounted on a support shaft different from the support shaft 63 of the first separating unit 61 and the configuration in which a structure in which part of the first separating unit 61 is connected by a connecting member may be adopted. Even when such a configuration is adopted, the second separating unit 65 is provided to move in coordination with movement of the first separating unit 61. As a configuration provided to maintain a stationary state, a configuration may be adopted in which the first separating unit 61 and the second separating unit 65 are integrally formed and manufactured.

The projection guidance unit 69 provided in the first separating unit 61 may be provided in the second separating unit 65 or the fixed frame 70. In the sheet separator 6, instead of the projection guidance unit 69, for instance, a guiding unit like a plate-like rotational body (a star wheel, for instance) having an outer circumference in which multiple blade-like projections are disposed in its entirety is applicable.

For the sheet separator 6 (including the sheet separator 6C in the modification), three or more sheet separators 6 may be used, and may be disposed in the width direction J of the intermediate transfer belt 31 with an interval. Incidentally, one sheet separator 6 may be disposed and used when such arrangement is effective.

The sheet separator 6 is not limited to a sheet separator that separates the sheet 9 from the intermediate transfer belt 31, and may be provided as a sheet separator that separates the sheet 9 from an image carrying unit such as a photoconductor drum, an intermediate transfer drum that carries an unfixed image to be transferred onto the sheet 9 and rotates.

In addition, in the first exemplary embodiment, as an image forming apparatus, the image forming apparatus 1 including the image former 2 and the intermediate transfer unit 3 capable of forming a multicolor (color) image configurated by developer has been illustrated. However, the present disclosure is applicable to an image forming apparatus including, for instance, an image former that forms a single color image as long as the image forming apparatus is supposed to include the sheet separator 6. The image former that forms a color image does not necessarily include the intermediate transfer unit 3, but may include an image former that uses a sheet transport transfer unit concurrently. When an image forming apparatus that forms a single color image is applied, the sheet separator 6 is disposed at a position on the downstream side of a transfer position at which an unfixed image is directly transferred from an image carrying unit such as a photoconductor onto the sheet 9.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
an image carrying unit that carries and rotates an unfixed image to be transferred to a recording medium;
a first separating unit that separates the recording medium from the image carrying unit with a first leading end of the first separating unit, in contact with the image carrying unit; and
a second separating unit that separates the recording medium from the image carrying unit with a second leading end of the second separating unit, not in contact with the image carrying unit,
wherein the second separating unit is disposed so that the first leading end is at a same position as the first leading end of the first separating unit or at a position on an upstream side of the first leading end of the first separating unit in a rotation direction of the image carrying unit.

2. The image forming apparatus according to claim 1,
wherein the second separating unit is provided to be maintained in a stationary state relative to the first separating unit.

3. The image forming apparatus according to claim 1,
wherein the second separating unit is provided to move in coordination with movement of the first separating unit.

4. The image forming apparatus according to claim 1,
wherein the second separating unit is provided fixed to the first separating unit.

5. The image forming apparatus according to claim 2,
wherein the second separating unit is provided fixed to the first separating unit.

6. The image forming apparatus according to claim 3,
wherein the second separating unit is provided fixed to the first separating unit.

7. The image forming apparatus according to claim 1,
wherein the first separating unit is provided to swing in a direction in which the first leading end is away from the image carrying unit, and the second separating unit moves in coordination with swing of the first separating unit.

8. The image forming apparatus according to claim 2,
wherein the first separating unit is provided to swing in a direction in which the first leading end is away from the image carrying unit, and the second separating unit moves in coordination with swing of the first separating unit.

9. The image forming apparatus according to claim 3,
wherein the first separating unit is provided to swing in a direction in which the first leading end is away from the image carrying unit, and the second separating unit moves in coordination with swing of the first separating unit.

10. The image forming apparatus according to claim 4,
wherein the first separating unit is provided to swing in a direction in which the first leading end is away from the image carrying unit, and the second separating unit moves in coordination with swing of the first separating unit.

11. The image forming apparatus according to claim 5,
wherein the first separating unit is provided to swing in a direction in which the first leading end is away from the image carrying unit, and the second separating unit moves in coordination with swing of the first separating unit.

12. The image forming apparatus according to claim 6,
wherein the first separating unit is provided to swing in a direction in which the first leading end is away from the image carrying unit, and the second separating unit moves in coordination with swing of the first separating unit.

13. The image forming apparatus according to claim 1,
wherein the second leading end of the second separating unit is disposed at a position on a downstream side, in the rotation direction of the image carrying unit, of a position in the image carrying unit, at which a leading end of the recording medium starts to separate naturally.

14. The image forming apparatus according to claim 2,
wherein the second leading end of the second separating unit is disposed at a position on a downstream side, in the rotation direction of the image carrying unit, of a position in the image carrying unit, at which a leading end of the recording medium starts to separate naturally.

15. The image forming apparatus according to claim 3,
wherein the second leading end of the second separating unit is disposed at a position on a downstream side, in the rotation direction of the image carrying unit, of a position in the image carrying unit, at which a leading end of the recording medium starts to separate naturally.

16. The image forming apparatus according to claim 4,
wherein the second leading end of the second separating unit is disposed at a position on a downstream side, in the rotation direction of the image carrying unit, of a position in the image carrying unit, at which a leading end of the recording medium starts to separate naturally.

17. The image forming apparatus according to claim 1,
wherein the first separating unit and the second separating unit are disposed with an interval between the first and second separating units in a direction of a rotation axis of the image carrying unit.

18. The image forming apparatus according to claim 1,
wherein the second separating unit is disposed at a position at least outward of the first separating unit in a direction of a rotation axis of the image carrying unit.

19. The image forming apparatus according to claim 13,
wherein the image carrying unit is an image carrying belt that is supported by a roller and rotated, the first leading end of the first separating unit is disposed at a position of a terminal point of winding around the roller of the image carrying belt or at a position on an upstream side of the winding terminal point in a rotation direction of the image carrying belt.

20. The image forming apparatus according to claim 1, further comprising
a guiding unit that guides the recording medium separated by the second separating unit, at a position in a direction in which the recording medium is away from the second separating unit, the position being rearward of the first separating unit and the second separating unit.
